(19) United States
(12) Patent Application Publication
(10) Pub. No.: US 2020/0363710 A1
(43) Pub. Date: Nov. 19, 2020

(54) WAVELENGTH CONVERSION COMPOSITE, PHOSPHOR PLATE, PHOSPHOR WHEEL, LIGHT SOURCE DEVICE, PROJECTION DISPLAY APPARATUS, AND METHOD OF MANUFACTURING THE WAVELENGTH CONVERSION COMPOSITE

(71) Applicant: Panasonic Intellectual Property Management Co., Ltd., Osaka (JP)

(72) Inventors: Takashi IKEDA, Osaka (JP); Makoto MAEDA, Nara (JP); Manabu OKUNO, Osaka (JP)

(21) Appl. No.: 16/870,150

(22) Filed: May 8, 2020

(30) Foreign Application Priority Data
May 13, 2019 (JP) 2019-090614

(51) Int. Cl. G03B 21/20; G02B 26/00; G03B 21/00

(52) U.S. Cl. CPC G03B 21/204; G02B 26/008; B28B 11/24; G03B 21/008; G03B 21/2066; G03B 21/2013

(57) ABSTRACT

A wavelength conversion composite includes a plurality of light-incident layers for emitting lights of different wavelength ranges in response to an incident light. The plurality of light-incident layers are disposed in layers on the same plane, adjacent edges of two adjacent light-incident layers among the plurality of light-incident layers being in contact with each other so that the plurality of light-incident layers form an integral whole.

### BACKGROUND

### 1. Technical Field

The present disclosure relates to a wavelength conversion composite that can emits lights of different wavelength ranges in response to an incident light of a predetermined wavelength range. The disclosure also relates to a phosphor plate, a phosphor wheel, a light source device, and a projection display apparatus, each of which includes such a wavelength conversion composite. The disclosure also relates to a method of manufacturing the wavelength conversion composite.

### 2. Description of the Related Art

Patent Literature (PTL) 1 discloses a light source device that can generate lights of different wavelength ranges in a time division manner using a phosphor wheel and combine these lights to emit a white light.

PTL 1 is Japanese Unexamined Patent Application Publication No. 2012-212129.

### SUMMARY

A plurality of light-incident layers (e.g., phosphors) having different optical characteristics are required to be aligned accurately on the substrate of a phosphor wheel to emit lights of different wavelength ranges in response to an incident light of a predetermined wavelength range using the phosphor wheel. Such accurate alignment of the layers increases the production cost as the number of alignment positions increases. Under such circumstances, a phosphor wheel and its components as well as a light source device and a projection display apparatus that include the phosphor wheel are desired to be manufactured accurately and at low cost by reducing the alignment trouble.

An object of the present disclosure is to provide a wavelength conversion composite that is manufactured accurately and at low cost and can be used, for example, in a phosphor wheel.

A wavelength conversion composite according to an aspect of the present disclosure includes a plurality of light-incident layers for emitting lights of different wavelength ranges in response to an incident light. The plurality of light-incident layers are disposed in layers on the same plane, adjacent edges of two adjacent light-incident layers among the plurality of light-incident layers being in contact with each other so that the plurality of light-incident layers form an integral whole.

The wavelength conversion composite according to the aspect of the present disclosure is manufactured accurately and at low cost, allowing a phosphor plate, a phosphor wheel, a light source device, and a projection display apparatus each including the wavelength conversion composite to be manufactured accurately and at low cost.

### BRIEF DESCRIPTION OF DRAWINGS

FIG. 1 is a sectional view of wavelength conversion composite 1 according to a first exemplary embodiment;

FIG. 2 is a sectional view of wavelength conversion composite 2 according to a modified example of the first exemplary embodiment;

FIG. 3 shows a method of manufacturing wavelength conversion composite 3 according to the first exemplary embodiment;

FIG. 4 is a sectional view of phosphor plate 4 according to a second exemplary embodiment;

FIG. 5A is a front view of phosphor wheel 5 according to a third exemplary embodiment;

FIG. 5B is a sectional view taken along line 5B-5B of FIG. 5A;

FIG. 6A is a front view of phosphor wheel 6 according to a first modified example of the third exemplary embodiment;

FIG. 6B is a sectional view take along line 6B-6B of FIG. 6A;

FIG. 7A is a front view of phosphor wheel 7 according to a second modified example of the third exemplary embodiment;

FIG. 7B is a sectional view taken along line 7B-7B of FIG. 7A;

FIG. 8A is a front view of phosphor wheel 8 according to a third modified example of the third exemplary embodiment;

FIG. 8B is a sectional view taken along line 8B-8B of FIG. 8A;

FIG. 9 is a configuration of light source device 9 according to a fourth exemplary embodiment;

FIG. 10 is a configuration of light source device 10 according to a first modified example of the fourth exemplary embodiment;

FIG. 11 is a configuration of light source device 11 according to a second modified example of the fourth exemplary embodiment;

FIG. 12 is a configuration of projection display apparatus 12 according to a fifth exemplary embodiment;

FIG. 13 is configuration of projection display apparatus 13 according to a first modified example of the fifth exemplary embodiment;

FIG. 14 is a configuration of projection display apparatus 14 according to a second modified example of the fifth exemplary embodiment; and

FIG. 15 is a configuration of projection display apparatus 15 according to a third modified example of the fifth exemplary embodiment.

### DETAILED DESCRIPTION

Exemplary embodiments will be described in detail as follows with reference to the accompanying drawings. However, the description of well-known matters and of substantially the same configuration as described earlier may be omitted to avoid redundancy and help those skilled in the art understand them easily.

Note that the attached drawings and the following description are provided to make those skilled in the art fully understand the present disclosure, and are not intended to limit the claimed subject matter.

### First Exemplary Embodiment

A wavelength conversion composite according to the first exemplary embodiment will now be described in detail.

### 1-1. The Configuration of the Wavelength Conversion Composite

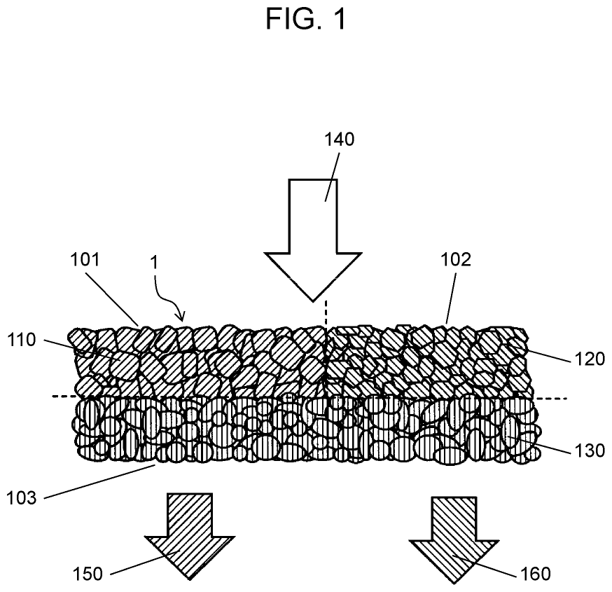

FIG. 1 is a sectional view of wavelength conversion composite 1 according to the first exemplary embodiment.

Composite 1 includes at least two light-incident layers. In the example of FIG. 1, composite 1 includes three light-incident layers 101, 102, and 103. These layers 101, 102, and 103 are sintered bodies of wavelength conversion particles 110, 120, and 130, respectively. Particles 110 and 120 emit respective lights of different wavelength ranges in response to an incident light. As a result, layers 101 and 102 respectively emit emission lights 150 and 160 of different wavelength ranges in response to incident light 140.

Light-incident layers 101 and 102 are disposed side by side on the same plane in contact with each other at their adjacent edges so that these layers form an integral whole. In the following description, disposing a plurality of layers side by side on the same plane like layers 101 and 102 is referred to as being formed as a single layer. Light-incident layer 103 is disposed on a surface (the bottom surface in FIG. 1) of layers 101 and 102 so as to function as a support layer for supporting these layers 101 and 102. The first light-incident layer 101 and the second light-incident layer 102 are in contact with each other and are further in contact with the third light-incident layer 103 on the same side. In other words, composite 1 is a multilayer board in which layers 101 and 102 are laminated on layer 103.

In the example of FIG. 1, incident light 140 enters the top surface (the opposite side from layer 103) of layers 101 and 102, passes through layers 101, 102, and 130, and is emitted as lights 150 and 160 through the bottom surface of layer 103.

At least one of layers 101 and 102 is composed of wavelength conversion particles that emit a light of a wavelength range different from the wavelength range of the incident light. The wavelength conversion particles are an example of wavelength conversion materials. The wavelength conversion particles may contain a YAG(Y₃Al₅O₁₂) phosphor, which converts a blue or ultraviolet incident light (an incident light of a blue or ultraviolet wavelength range) into a yellow light (a light of a yellow wavelength range). The wavelength conversion particles may alternatively contain a LuAG(Lu₃Al₅O₁₂) phosphor, which converts a blue or ultraviolet incident light into a green light (a light of a green wavelength range). In the YAG phosphor, Y is partially replaced by an activator Ce with an arbitrary concentration. The YAG phosphor can change the converted wavelength range by changing the concentration of the activator Ce. A YAG phosphor containing an activator Ce with a concentration of 0% functions as a transparent material. In this case, the wavelength range of the incident light remains unchanged, so that the emission light has the same wavelength range as the incident light.

Thus, particles 110 and 120 may be made of YAG phosphors containing activators Ce with different concentrations other than zero. Alternatively, either particles 110 or 120 may be made of a YAG phosphor containing an activator Ce with a non-zero concentration, and the other may be made of a LuAG phosphor. In these cases, emission lights 150 and 160 have wavelength ranges different from that of incident light 140. The term “non-zero” indicates a value other than zero. An activator Ce with a non-zero concentration means an activator Ce with a concentration of other than 0%.

Wavelength conversion particles 130 may be a YAG phosphor containing an activator Ce with a non-zero concentration, a LuAG phosphor, or a YAG phosphor containing an activator Ce with a concentration of 0%. For example, the YAG phosphor containing an activator Ce with a non-zero concentration (or the LuAG phosphor) can be used for particles 110 alone, and the YAG phosphor containing an activator Ce with a concentration of 0% can be used for particles 120 and 130. In this case, incident light 140 keeps its original wavelength range while passing through layers 102 and 103, so that emission light 160 has the same wavelength range as incident light 140.

The wavelength conversion particles used in the above-described example are made of either a YAG phosphor or a LuAG phosphor, but may alternatively be made of other phosphors.

In the structure shown in FIG. 1, layer 103 coats layers 101 and 102 so as to increase the strength of wavelength conversion composite 1; however, layer 103 is dispensable if layers 101 and 102 are strongly integrated.

A wavelength conversion composite according to the modified example of the first exemplary embodiment will now be described in detail.

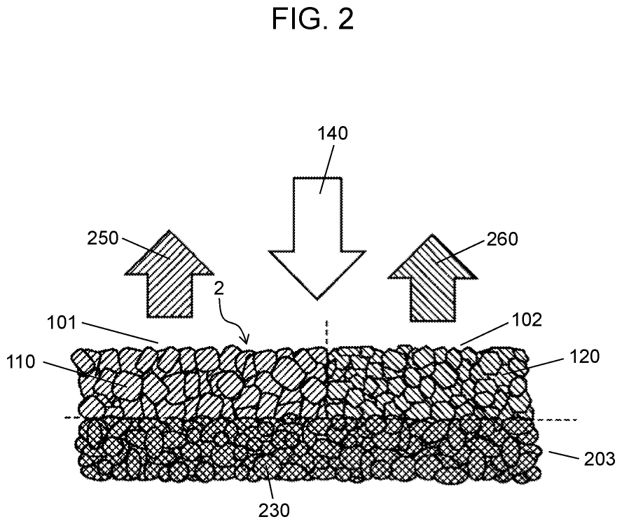

FIG. 2 is a sectional view of wavelength conversion composite 2 according to the modified example of the first exemplary embodiment.

Composite 2 includes light-incident layer 203 instead of light-incident layer 103 shown in FIG. 1. Because light-incident layers 101 and 102 shown in FIG. 2 are identical to their counterparts shown in FIG. 1, their detailed description will be omitted. The following description will be focused on light-incident layer 203, which is not included in composite 1 shown in FIG. 1.

Similar to layer 103 shown in FIG. 1, layer 203 is disposed on a surface (the bottom surface in FIG. 2) of layers 101 and 102 so as to function as a support layer for supporting these layers 101 and 102. Layer 203 is composed of constituent particles 230 having a high refractive index. Particles 230 can be used as a reflective material with high reflectivity by sintering into ceramics. Particles 230 can be made, for example, of titanium oxide particles or other particles.

In the example of FIG. 2, incident light 140 enters the top surface of layers 101 and 102, passes through layers 101 and 102, and is reflected by layer 203. Light 140 passes back through layers 101 and 102, and is emitted as emission lights 250 and 260 through the top surface (the same side as the incident light 140 enters) of layers 101 and 102.

Thus, similar to the example of FIG. 1, in wavelength conversion composite 2 of FIG. 2, the materials for wavelength conversion particles 110 and 120 can be properly selected to control the wavelength ranges of emission lights 250 and 260.

Either particles 110 or 120 can be made of a YAG phosphor containing an activator Ce with a concentration of 0% so that either emission light 250 or 260 can have the same wavelength range as incident light 140.

### 1-2. A Method of Manufacturing the Wavelength Conversion Composite

A method of manufacturing a wavelength conversion composite according to the first exemplary embodiment will now be described in detail.

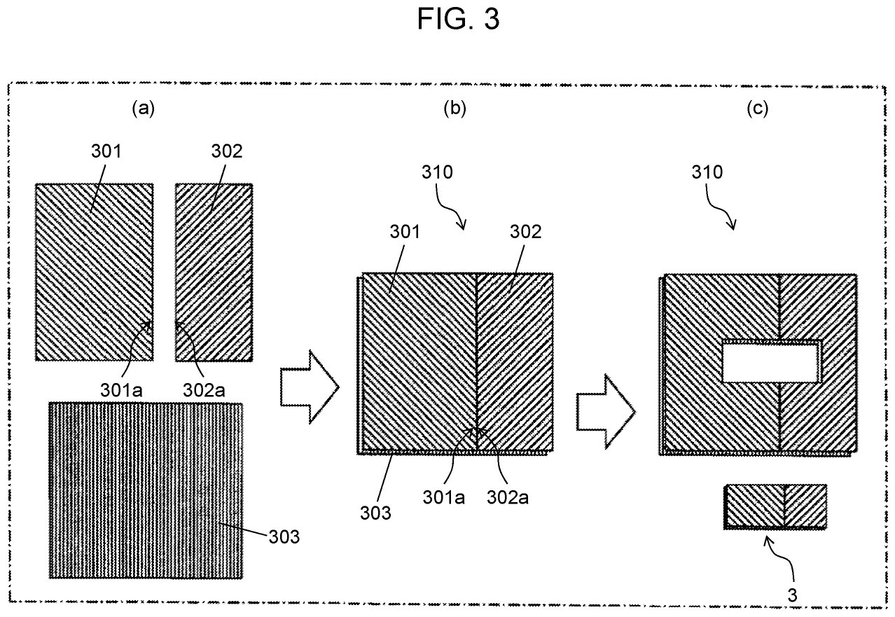

FIG. 3 shows the method of manufacturing wavelength conversion composite 3. FIG. 3(a) shows material sheets 301, 302, and 303 containing respective wavelength conversion particles before these sheets are laminated and bonded together. FIG. 3(b) shows material composite 310 obtained by laminating and bonding material sheets 301, 302, and 303 together.

FIG. 3(c) shows wavelength conversion composite 3 cut out from material composite 310 of FIG. 3(b).

First, as shown in FIG. 3(a), the materials for the wavelength conversion particles are added to a predetermined solvent to prepare a slurry, which is molded into material sheets 301, 302, and 303 that are yet to be sintered.

Next, as shown in FIG. 3(b), material sheets 301 and 302 are placed on material sheet 303. Sheets 301 and 302 are placed side by side in contact with each other at their adjacent edges 301a and 302a. Thus, material sheets 301, 302, and 303 are integrally laminated to form material composite 310. Next, material composite 310 is sintered.

As shown in FIG. 3(c), wavelength conversion composite 3 is cut out from material composite 310 either before or after sintering.

Thus, a plurality of light-incident layers are disposed side by side on the same plane in contact with each other at their adjacent edges so that these layers form an integral whole.

The example of FIG. 3 shows three material sheets 301, 302, and 303; alternatively, however, four or more material sheets may be used for a wavelength conversion composite. For example, three or more material sheets may be disposed on material sheet 303. Still alternatively, material sheet 303 is dispensable.

In the example of FIG. 3, wavelength conversion composite 3 that has been cut out from material composite 310 is rectangular, but may alternatively, be, for example, ring-shaped or ring segment-shaped.

### 1-3. Effects of the Wavelength Conversion Composites

Wavelength conversion composites 1, 2, and 3 according to the first exemplary embodiment have the following configuration.

Each of composites 1, 2, and 3 includes light-incident layers 101 and 102 that can emit lights of different wavelength ranges in response to an incident light. Layers 101 and 102 are disposed side by side on the same plane in contact with each other at their adjacent edges so that these layers form an integral whole.

In composites 1, 2, and 3, at least one of layers 101 and 102 may be made of a wavelength conversion material that emits a light of a wavelength range different from the wavelength range of the incident light.

Composites 1, 2, and 3 may further include a support layer (namely, light-incident layer 103 or 203) disposed on a surface of layers 101 and 102 so as to support these layers 101 and 102.

In composites 1 and 3, the support layer (namely, light-incident layer 103) may be made of a transparent material.

In composites 2 and 3, the support layer (namely, light-incident layer 203) may be made of a reflective material.

In composites 2 and 3, the reflective material for the support layer (namely, light-incident layer 203) may be sintered titanium oxide.

In composites 1, 2, and 3, the support layer (namely, light-incident layer 103) may be made of a wavelength conversion material that emits a light of a wavelength range different from the wavelength range of the incident light.

The method of manufacturing composites 1, 2, and 3 includes molding a yet-to-be-sintered material for light-incident layers 101 and 102, and integrally sintering the molded material for layers 101 and 102.

Thus, the method shown in FIG. 3 allows the wavelength conversion composite shown in FIG. 1 or 2 to be manufactured accurately and at low cost. The wavelength conversion composite has sufficient strength and the ability of emitting lights of different wavelength ranges in response to an incident light of a predetermined wavelength range. In addition, as will be described later, such a wavelength conversion composite can be used in a phosphor plate, a phosphor wheel, a light source device, or a projection display apparatus to improve the alignment accuracy during manufacture. This improves the yield and reduces the cost.

### Second Exemplary Embodiment

A phosphor plate according to the second exemplary embodiment will now be described in detail.

### 2-1. The Configuration of the Phosphor Plate

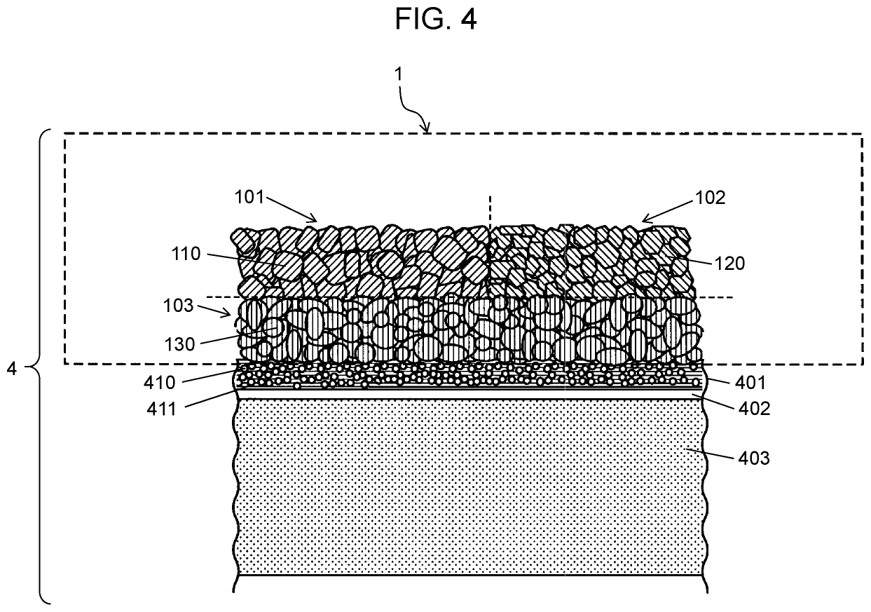

FIG. 4 is a sectional view of phosphor plate 4 according to the second exemplary embodiment.

In FIG. 4, phosphor plate 4 includes wavelength conversion composite 1, adhesive layer 401, reflective layer 402, and substrate 403. Reflective layer 402 is disposed on a surface of substrate 403, and composite 1 is fixed on reflective layer 402 via adhesive layer 401.

Composite 1 shown in FIG. 4 has the same structure as composite 1 of the first exemplary embodiment shown in FIG. 1, so that it will not be described again in detail.

Adhesive layer 401 contains a mixture of filler particles 410 and binder 411. Filler particles 410, which have the property of improving reflectivity and/or thermal conductivity, can be, for example, titanium oxide particles.

Binder 411 is, for example, silicone.

Substrate 403 is made, for example, of a metal (e.g., copper or aluminum).

In the example of FIG. 4, similar to the example of FIG. 1, the incident light enters the top surface of light-incident layers 101 and 102, passes through these layers 101, 102, and 103, and is emitted as emission lights through the bottom surface of layer 103. However, the light passing through layers 101, 102, and 103 can travel in the opposite direction (180 degrees) depending on reflective layer 402 or a combination of adhesive layer 401 and reflective layer 402. To be more specific, the light passes back through layers 101, 102, and 103 and is emitted as emission lights through the top surface (the same side as the incident light enters) of layers 101 and 102.

Phosphor plate 4 may include two or more wavelength conversion composites 1 fixed at two or more regions on a surface of substrate 403 (see the third modified example of the third exemplary embodiment, which will be described later).

Reflective layer 402 disposed between composite 1 and substrate 403 in the example of FIG. 4 is dispensable.

Phosphor plate 4 may include composite 2 of the modified example of the first exemplary embodiment instead of composite 1 of the first exemplary embodiment. In this case, filler particles 410 of adhesive layer 401 can be selected with consideration of improving only thermal conductivity because their reflectivity does not need to be considered. Provided that sufficient reflectivity can be obtained by light-incident layer 203 of composite 2 or by a combination of light-incident layer 203 and adhesive layer 401, reflective layer 402 is dispensable.

### 2-2. Effects of the Phosphor Plate

Phosphor plate 4 according to the second exemplary embodiment has the following configuration.

Phosphor plate 4 includes wavelength conversion composite 1, 2, or 3 and substrate 403. Composite 1, 2, or 3 and substrate 403 are fixedly bonded to each other.

Phosphor plate 4 may further include reflective layer 402 between composite 1, 2, or 3 and substrate 403.

Thus, in the configuration shown in FIG. 4, wavelength conversion composite 1 is fixed onto substrate 403. This enables the phosphor plate to be manufactured easily, accurately, and at low cost without aligning a plurality of light-incident layers having different optical characteristics, the phosphor plate having the ability of emitting lights of different wavelength ranges in response to an incident light of a predetermined wavelength range. This phosphor plate can be used in a phosphor wheel, a light source device, or a projection display apparatus to improve the alignment accuracy during manufacture. This improves the yield and reduces the cost.

### Third Exemplary Embodiment

A phosphor wheel according to the third exemplary embodiment will now be described in detail.

### 3-1. The Configuration of the Phosphor Wheel

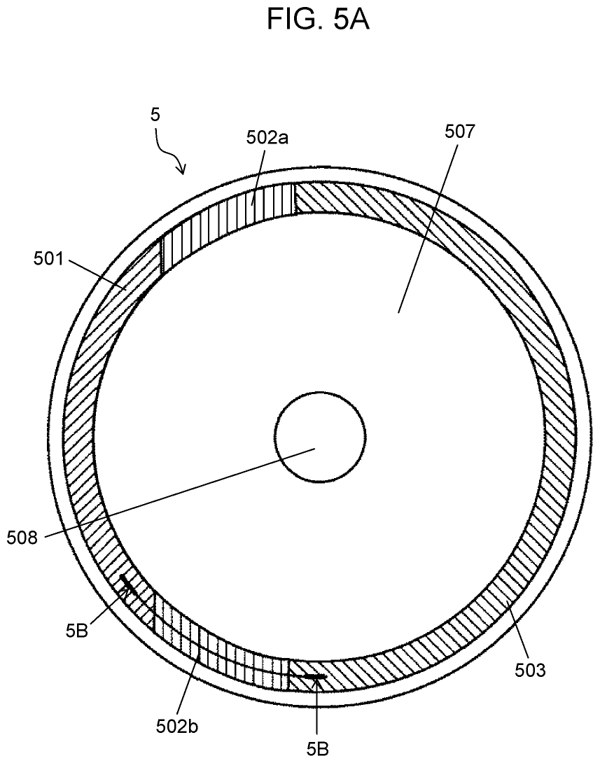

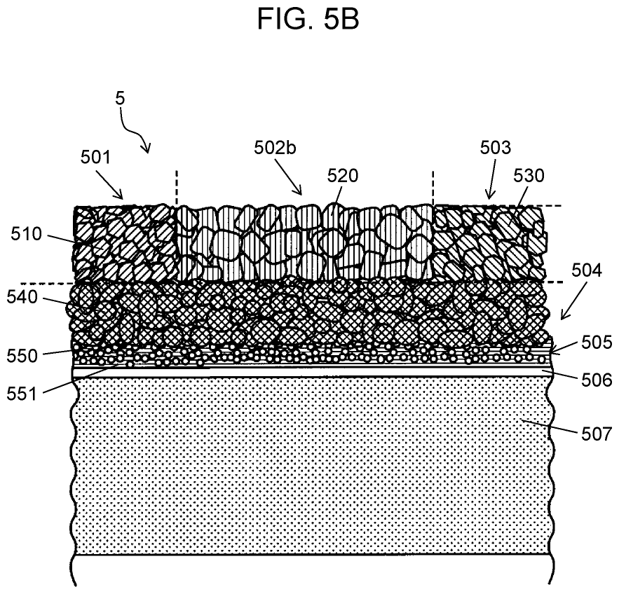

FIGS. 5A and 5B show the configuration of phosphor wheel 5 according to the third exemplary embodiment. FIG. 5A is a front view of phosphor wheel 5, and FIG. 5B is a sectional view taken along line 5B-5B of FIG. 5A.

As shown in FIGS. 5A and 5B, phosphor wheel 5 includes a wavelength conversion composite that includes light-incident layers 501, 502a, 502b, 503, and 504; adhesive layer 505; reflective layer 506; substrate 507; and motor 508. In FIG. 5A, light-incident layers 502a and 502b, which are collectively referred to as light-incident layers 502, are made of the same material. Reflective layer 506 is disposed on a surface of circular substrate 507, and the wavelength conversion composite including layers 501 to 504 is fixed on reflective layer 506 via adhesive layer 505. Motor 508 rotates substrate 507 about its center.

Adhesive layer 505 contains a mixture of filler particles 550 and binder 551. Adhesive layer 505 has the same structure as adhesive layer 401 shown in FIG. 4.

Reflective layer 506 has the same structure as reflective layer 402 shown in FIG. 4.

Substrate 507 is made, for example, of a metal such as aluminum or other materials. Substrate 507 made of aluminum is suitable for use in a phosphor wheel because of its lightness in weight and high thermal conductivity.

Light-incident layers 501, 502, and 503 emit lights of different wavelength ranges in response to an incident light. Layers 501, 502, and 503 are disposed side by side on the same plane in contact with each other at their adjacent edges so that these layers form an integral whole. Layer 504 is disposed on a surface (the bottom surface in FIG. 5B) of layers 501, 502, and 503 so as to function as a support layer for supporting these layers 501, 502, and 503. Thus, layers 501, 502, 503, and 504 constitute the wavelength conversion composite described in the first exemplary embodiment.

As shown in FIG. 5A, layers 501, 502, and 503 have the shape of ring segments having different angle ranges in a ring with a predetermined radius. Layer 504 is also ring-shaped and has the same radius as that of layers 501, 502, and 503. Thus, the wavelength conversion composite shown in FIGS. 5A and 5B has the shape of a ring with the predetermined radius. Phosphor wheel 5 is produced by cutting out the ring-shaped wavelength conversion composite from material composite 310 shown in FIG. 3, and then fixing this composite to substrate 507 (to be more specific, fixing light-incident layer 504 to reflective layer 506 via adhesive layer 505).

Light-incident layers 501, 502, 503, and 504 are sintered bodies of wavelength conversion particles 510, 520, 530, and 540, respectively. At least one of layers 501, 502, and 503 is composed of wavelength conversion particles that emit a light of a wavelength range different from the wavelength range of the incident light. The wavelength conversion particles are an example of wavelength conversion materials. Particles 510 may contain a LuAG phosphor that converts a blue incident light into a green light. Particles 530 may contain a YAG phosphor that contains an activator Ce with a non-zero concentration and converts a blue incident light into a yellow light. Particles 520 and 540 may contain a YAG phosphor that contains an activator Ce with a concentration of 0% and emits a blue light by keeping the wavelength range of a blue incident light unchanged.

In phosphor wheel 5 of FIG. 5A, assume that substrate 507 rotates counterclockwise and the spot of the incident light moves clockwise in the following order: layer 501, layer 502a, layer 503, layer 502b, layer 501, . . . . In this case, the lights are emitted in the following order of colors: green, blue, yellow, blue, green, . . . .

Particles 530 may contain a phosphor that converts a blue incident light into a red light, instead of a phosphor that converts a blue incident light into a yellow light. Particles 520 may contain a phosphor that converts a blue incident light into a slightly different wavelength of blue light instead of a YAG phosphor (a transparent material) containing an activator Ce with a concentration of 0%. Particles 540 may contain a phosphor that converts a blue incident light into green and yellow lights instead of a YAG phosphor (a transparent material) containing an activator Ce with a concentration of 0%.

Each light-incident layer may emit a green, blue, yellow, or red light in response to an ultraviolet incident light instead of the blue incident light.

In the example of FIG. 5A, a green light is emitted from one layer 501, blue lights are emitted from two layers 502a and 502b, and a yellow light is emitted from one layer 503. Alternatively, however, green, blue, and yellow lights may be emitted from light-incident layers whose number is different from that of light-incident layers in the example of FIG. 5A.

The example of FIG. 5A describes a ring-shaped wavelength conversion composite. Alternatively, at least one wavelength conversion composite and at least one other light-incident layer each having the shape of a ring segment may be combined together, arranged in the shape of a ring, and fixedly bonded to substrate 507.

Phosphor wheel 5 may include composite 2 of the modified example of the first exemplary embodiment instead of composite 1 of the first exemplary embodiment. In this case, phosphor wheel 5 includes a light-incident layer made of a reflective material instead of light-incident layer 504 shown in FIG. 5B.

A phosphor wheel according to the first modified example of the third exemplary embodiment will now be described in detail.

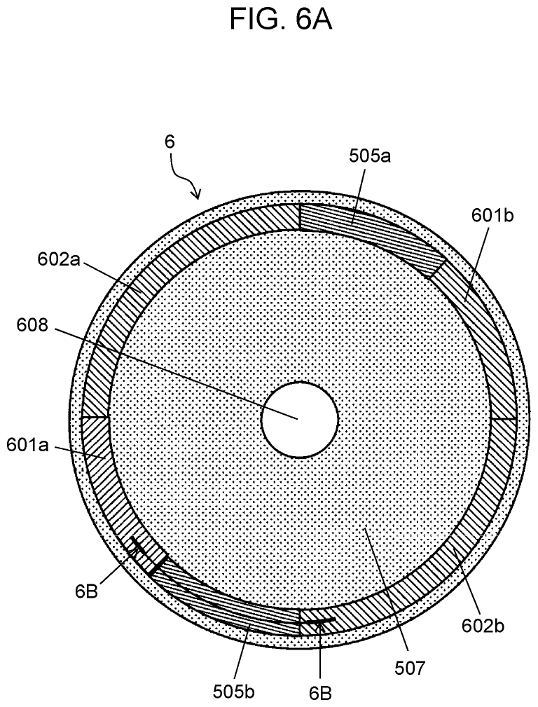

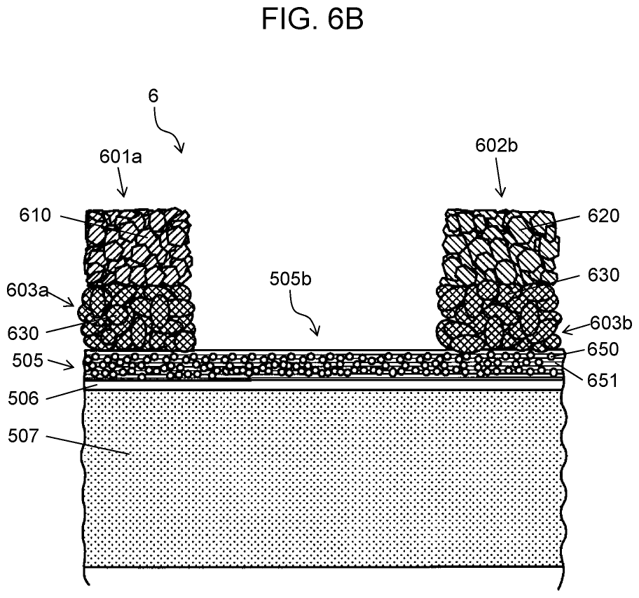

FIGS. 6A and 6B show the configuration of phosphor wheel 6 according to the first modified example of the third exemplary embodiment. FIG. 6A is a front view of phosphor wheel 6, and FIG. 6B is a sectional view taken along line 6B-6B of FIG. 6A.

As shown in FIGS. 6A and 6B, phosphor wheel 6 includes a first wavelength conversion composite including light-incident layers 601a, 602a, and 603a; a second wavelength conversion composite including light-incident layers 601b, 602b, and 603b; adhesive layer 505; reflective layer 506; substrate 507; and motor 508. In FIG. 6A, light-incident layers 601a and 601b are made of the same material and collectively referred to as light-incident layers 601;

light-incident layers 602a and 602b are made of the same material and collectively referred to as light-incident layers 602; and in FIG. 6B, light-incident layers 603a and 603b are made of the same material and collectively referred to as light-incident layers 603. Adhesive layers 505a and 505b in FIG. 6A are part of adhesive layer 505. Reflective layer 506 is disposed on a surface of circular substrate 507, and the two wavelength conversion composites are fixed on reflective layer 506 via adhesive layer 505.

Adhesive layer 505, reflective layer 506, substrate 507, and motor 508 shown in FIGS. 6A and 6B have the same structures as their counterparts shown in FIGS. 5A and 5B.

Layers 601a and 602a emit lights of different wavelength ranges in response to an incident light. Layers 601a and 602a are disposed side by side on the same plane in contact with each other at their adjacent edges so that these layers form an integral whole. Layer 603a is disposed on a surface (the bottom surface in FIG. 6B) of layers 601a and 602a so as to function as a support layer for supporting these layers 601a and 602a. Thus, layers 601a, 602a, and 603a constitute the wavelength conversion composite described in the first exemplary embodiment. Similarly, layers 601b, 602b, and 603b constitute the wavelength conversion composite described in the first exemplary embodiment.

As shown in FIG. 6A, layers 601a and 602a have the shape of ring segments having different angle ranges in a ring with a predetermined radius. Layer 603a has the shape of a ring segment equal to the sum of the angle ranges of layers 601a and 602a. Thus, the wavelength conversion composite including layers 601a, 602a, and 603a has the shape of a ring segment. Similarly, the wavelength conversion composite including layers 601b, 602b, and 603b has the shape of a ring segment. Phosphor wheel 6 is prepared as follows. First, the two wavelength conversion composites each having the shape of a ring segment are cut out from material composite 310 shown in FIG. 3. Next, these composites are arranged in an approximate ring and fixedly bonded to substrate 507 (to be more specific, light-incident layers 603a and 603b are fixed to reflective layer 506 via adhesive layer 505). In the example of FIG. 6A, adhesive layer 505 is formed in the ring-shaped region except that adhesive layers 505a and 505b are exposed without contributing to the fixation of the wavelength conversion composites.

Layers 601, 602, and 603 are sintered bodies of wavelength conversion particles 610, 620, and 630, respectively. At least one of layers 601, 602, and 603 is composed of wavelength conversion particles that emit a light of a wavelength range different from the wavelength range of the incident light. The wavelength conversion particles are an example of wavelength conversion materials. Particles 610 may contain a LuAG phosphor that converts a blue incident light into a green light. Particles 620 may contain a YAG phosphor that contains an activator Ce with a non-zero concentration and converts a blue incident light into a yellow light. Particles 630 may contain a YAG phosphor that contains an activator Ce with a concentration of 0% and emits a blue light by keeping the wavelength range of a blue incident light unchanged.

In phosphor wheel 6 of FIG. 6A, assume that substrate 507 rotates counterclockwise and the spot of the incident light moves clockwise in the following order: light-incident layer 601a, light-incident layer 602a, adhesive layer 505a, light-incident layer 601b, light-incident layer 602b, adhesive layer 505b, light-incident layers 601a, . . . . In this case, the lights are emitted in the following order of colors: green, yellow, blue, green, yellow, blue, green, . . . .

Similar to phosphor wheel 5 of the third exemplary embodiment, light-incident layers 601, 602, and 603 in phosphor wheel 6 may be composed of a material having optical characteristics (e.g., wavelength characteristics) different from those of the above-mentioned wavelength conversion particles 610, 620, and 630.

In the example of FIG. 6A, adhesive layer 505 is formed in the ring-shaped region. Alternatively, the parts of adhesive layer 505 (i.e., adhesive layers 505a and 505b in FIG. 6A) that do not contribute to the fixation of the wavelength conversion composites may be eliminated, allowing reflective layer 506 to be exposed.

Phosphor wheel 6 may include composite 2 of the modified example of the first exemplary embodiment instead of composite 1 of the first exemplary embodiment. In this case, phosphor wheel 6 includes a light-incident layer made of a reflective material instead of light-incident layer 603 shown in FIG. 6B.

A phosphor wheel according to the second modified example of the third exemplary embodiment will now be described in detail.

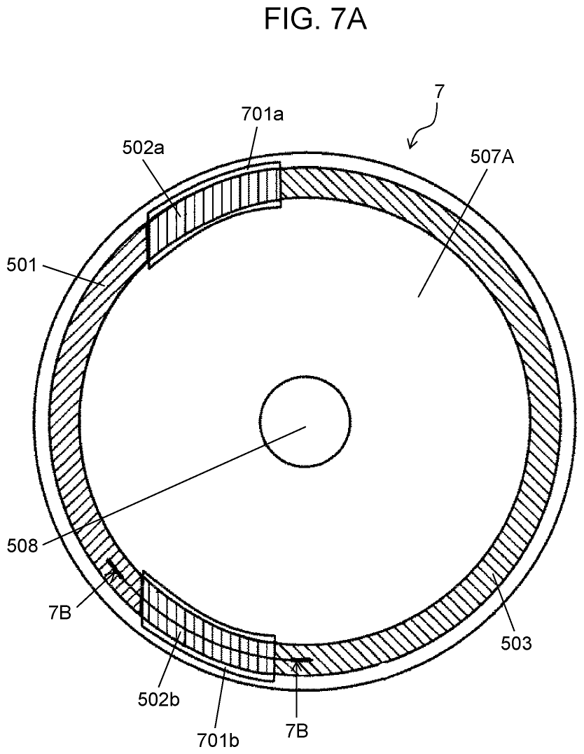

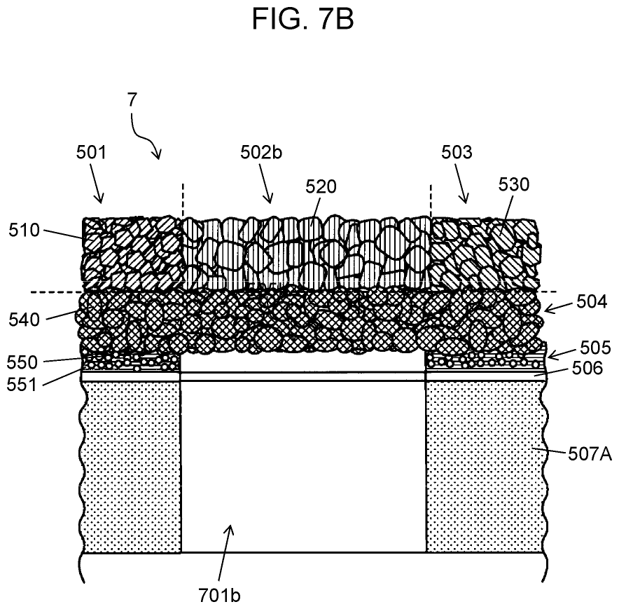

FIGS. 7A and 7B show the configuration of phosphor wheel 7 according to the second modified example of the third exemplary embodiment. FIG. 7A is a front view of phosphor wheel 7, and FIG. 7B is a sectional view taken along line 7B-7B of FIG. 7A.

As shown in FIGS. 7A and 7B, phosphor wheel 7 includes substrate 507A instead of substrate 507 of phosphor wheel 5 shown in FIGS. 5A and 5B. Substrate 507A is disc-shaped like substrate 507 shown in FIG. 5A, and further has openings 701a and 701b. The other components of phosphor wheel 7 have the same structures as their counterparts of phosphor wheel 5 shown in FIGS. 5A and 5B.

As described above, light-incident layers 502a and 502b are transmissive elements made of a transparent material. Openings 701a and 701b are located at the same distance from the center of substrate 507A as the radius of the ring-shaped wavelength conversion composite (i.e., light-incident layers 501, 502, 503, and 504). When the wavelength conversion composite is fixedly bonded to substrate 507A, light-incident layers 502a and 502b are vertically aligned with openings 701a and 701b.

In phosphor wheel 7 of FIG. 7A, assume that substrate 507A rotates counterclockwise and the spot of the incident light moves clockwise in the following order: layer 501, layer 502a, layer 503, layer 502b, layer 501, . . . . In this case, the lights are emitted in the following order of colors: green, blue, yellow, blue, green, . . . . In this situation, the green and yellow lights are reflected by reflective layer 506 and travel against the direction of the incident light. Meanwhile, the blue lights pass through openings 701a and 701b and are emitted in the same direction as the incident light travels.

Substrate 507A may have openings or cutout portions with other shapes than those of openings 701a and 701b shown in FIG. 7A.

Furthermore, substrate 507A may be made of a metal such as aluminum like substrate 507 shown in FIGS. 5A and 5B or made of a transparent material such as glass or sapphire. A substrate made of a transparent material does not need openings or cutout portions.

Finally, a phosphor wheel according to the third modified example of the third exemplary embodiment will now be described in detail.

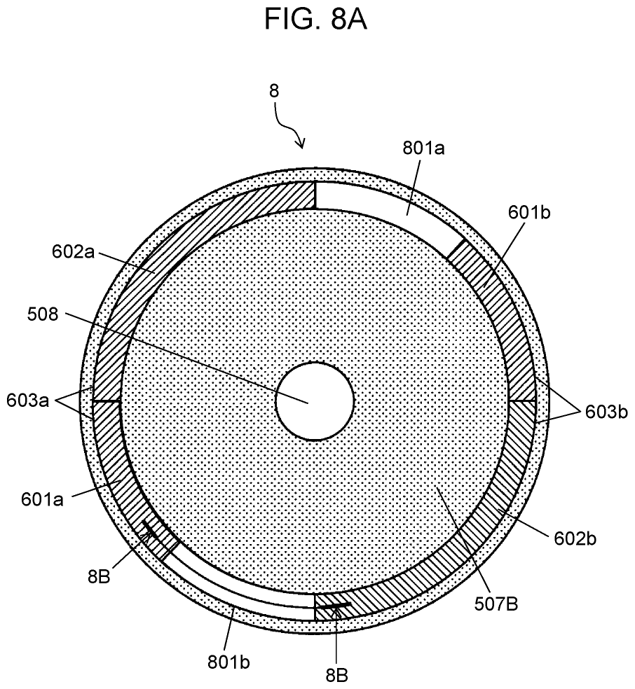

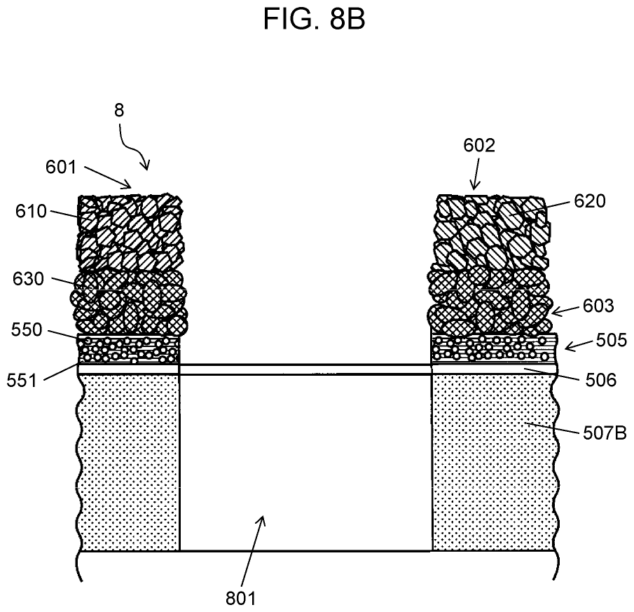

FIGS. 8A and 8B show the configuration of phosphor wheel 8 according to the third modified example of the third exemplary embodiment. FIG. 8A is a front view of phosphor wheel 8, and FIG. 8B is a sectional view taken along line 8B-8B of FIG. 8A.

As shown in FIGS. 8A and 8B, phosphor wheel 8 includes substrate 507B instead of substrate 507 of phosphor wheel 6 shown in FIGS. 6A and 6B. Substrate 507B is disc-shaped like substrate 507A shown in FIG. 7A, and further has openings 801a and 801b. The other components of phosphor wheel 8 have the same structures as their counterparts of phosphor wheel 6 shown in FIGS. 6A and 6B.

Openings 801a and 801b are located in regions having the shape of ring segments having predetermined angle ranges in a ring with a predetermined radius. Adhesive layer 505 is formed in a region having the shape of a ring segment having another angle range of the ring with the same radius. The first and second wavelength conversion composites are fixed to the region of adhesive layer 505. As mentioned above, the first wavelength conversion composite includes light-incident layers 601a, 602a, and 603a whereas the second wavelength conversion composite including light-incident layers 601b, 602b, and 603b.

In phosphor wheel 8 of FIG. 8A, assume that substrate 507B rotates counterclockwise and the spot of the incident light moves clockwise in the following order: layer 601a, layer 602a, opening 801a, layer 601b, layer 602b, opening 801b, layer 601a, . . . . In this case, the lights are emitted in the following order of colors: green, yellow, blue, green, yellow, blue, green, . . . . In this situation, the green and yellow lights are reflected by reflective layer 506 and travel against the direction of the incident light. Meanwhile, the blue lights pass through openings 801a and 801b and are emitted in the same direction as the incident light travels.

### 3-2. Effects of the Phosphor Wheels

Phosphor wheels 5, 6, 7, 8 according to the third exemplary embodiment have the following configuration.

Each of phosphor wheels 5, 6, 7, and 8 includes a phosphor plate and motor 508 for rotating the phosphor plate. Substrates 507, 507A, and 507B for use in the phosphor plate are disc-shaped. At least one wavelength conversion composite of the phosphor plate is either ring-shaped or ring segment-shaped.

In phosphor wheels 5, 6, 7, and 8, substrate 507A may have openings 701 (or cutout portions). At least one light-incident layer in the wavelength conversion composite may be aligned with openings 701 (or cutout portions) and be a transmissive element made of a transparent material.

Thus, the configurations shown in FIGS. 5A to 8B enable the manufacture of the phosphor wheels easily, accurately and at low cost. The phosphor wheels have the ability of emitting lights of different wavelength ranges in response to an incident light of a predetermined wavelength range by rotating the phosphor plate of the second exemplary embodiment without the need to align the light-incident layers having different optical characteristics. Such a phosphor wheel can be used in a light source device or a projection display apparatus to improve the alignment accuracy during manufacture. This improves the yield and reduces the cost.

### Fourth Exemplary Embodiment

Alight source device according to the fourth exemplary embodiment will now be described in detail.

### 4-1. The Configuration of the Light Source Device

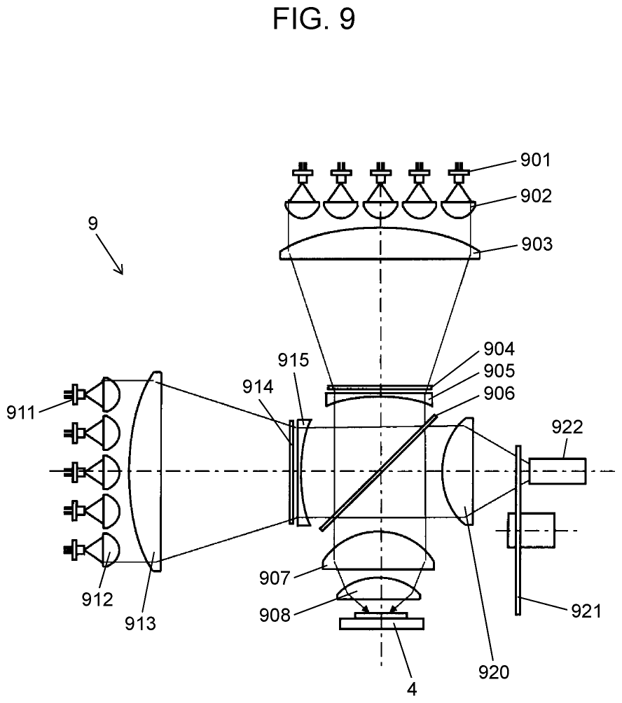

FIG. 9 shows the configuration of light source device 9 according to the fourth exemplary embodiment.

Light source device 9 includes phosphor plate 4 of the second exemplary embodiment.

Light source device 9 further includes a plurality of first semiconductor laser elements 901, a plurality of collimator lenses 902, convex lens 903, diffusion plate 904, concave lens 905, wavelength-selective mirror 906, and convex lenses 907 and 908. These optical components are examples of the optical system for guiding lights from first semiconductor laser elements 901 to phosphor plate 4.

Light source device 9 further includes a plurality of second semiconductor laser elements 911, a plurality of collimator lenses 912, convex lens 913, diffusion plate 914, and concave lens 915. These optical components are examples of the optical system for guiding lights from second semiconductor laser elements 911 to convex lens 920, which will be described later. Light source device 9 further includes convex lens 920, color wheel 921, and rod integrator 922.

The blue lights from first semiconductor laser elements 901 are collimated by respective collimator lenses 902 disposed on the emission side of elements 901. The collimated lights are converged by convex lens 903 disposed on the emission side of collimator lenses 902. The converged lights enter diffusion plate 904 disposed on the emission side of convex lens 903. Diffusion plate 904 reduces the ununiformity of the lights that remains unsolved by convex lens 903. The lights emitted through diffusion plate 904 enter concave lens 905 to be collimated.

The collimated lights emitted through concave lens 905 enter wavelength-selective mirror 906 disposed on the emission side of concave lens 905. Mirror 906 is disposed at an angle of 45 degrees with respect to the optical axis of the lights coming from concave lens 905. Mirror 906 has the property of transmitting blue lights of the wavelength range of first semiconductor laser elements 901 and second semiconductor laser elements 911, which will be described later, and reflecting lights of the other wavelength ranges (such as green and yellow). Thus, the lights emitted through concave lens 905 pass through mirror 906. After passing through mirror 906, the lights enter convex lenses 907 and 908 in that order to be converged, and the converged lights enter phosphor plate 4. Plate 4 is disposed so that light-incident layers 101 and 102 face convex lens 908.

Thus, the lights from first semiconductor laser elements 901 are converged by convex lenses 907 and 908, and enter light-incident layers 101, 102, and 103. This generates lights (fluorescent light) of different wavelength ranges, for example, green and yellow lights. The generated green and yellow lights enter convex lens 908 from phosphor plate 4. After being emitted through convex lens 908, the green and yellow lights enter convex lens 907 to be collimated. The collimated green and yellow lights enter mirror 906.

Wavelength-selective mirror 906 is disposed at an angle of 45 degrees with respect to the optical axis of the lights coming from convex lens 907. Mirror 906 has the property of reflecting green and yellow lights. As a result, the green and yellow lights coming from convex lens 907 are reflected by mirror 906 to be turned 90 degrees and enter convex lens 920.

Next, the blue lights from second semiconductor laser elements 911 are collimated by respective collimator lenses 912 disposed on the emission side of elements 911. The collimated lights are converged by convex lens 913 disposed on the emission side of collimator lenses 912. The converged lights enter diffusion plate 914 disposed on the emission side of convex lens 913. Diffusion plate 914 reduces the ununiformity of the lights that remains unsolved by convex lens 903. The lights emitted through diffusion plate 914 enter concave lens 915 to be collimated.

The collimated lights emitted through concave lens 915 enter wavelength-selective mirror 906 disposed on the emission side of concave lens 915. Mirror 906 is disposed at an angle of 45 degrees with respect to the optical axis of the lights coming from concave lens 915. Mirror 906 has the property of transmitting blue lights of the wavelength range of first semiconductor laser elements 901 and second semiconductor laser elements 911, and reflecting lights of the other wavelength ranges (such as green and yellow). Thus, the lights emitted through concave lens 915 pass through mirror 906. After passing through mirror 906, the lights travel straight to enter convex lens 920.

After entering convex lens 920, the green, yellow, and blue lights are converged by convex lens 920, pass through color wheel 921, and enter rod integrator 922.

Color wheel 921 includes a wavelength-selective coating that transmits only green, yellow, blue, and red lights of the mixture of the green, yellow, and blue lights emitted through convex lens 920. While color wheel 921 makes one rotation, rod integrator 922 emits green, yellow, blue, and red lights sequentially.

The fluorescent lights emitted from phosphor plate 4 are green and yellow in the above description, but may alternatively be green and red, or yellows having different wavelength ranges. Furthermore, color wheel 921, which is disposed on the incidence side of rod integrator 922, may alternatively be disposed on the emission side. Furthermore, color wheel 921, which contains the wavelength-selective coating that transmits only green, yellow, blue, and red lights, may alternatively contain a wavelength-selective coating that transmits only green, blue, and red lights. Furthermore, light source device 9 does not have to include color wheel 921. In this case, however, blue, green, and yellow lights are emitted as a mixture.

The configuration of a light source device according to the first modified example of the fourth exemplary embodiment will now be described in detail.

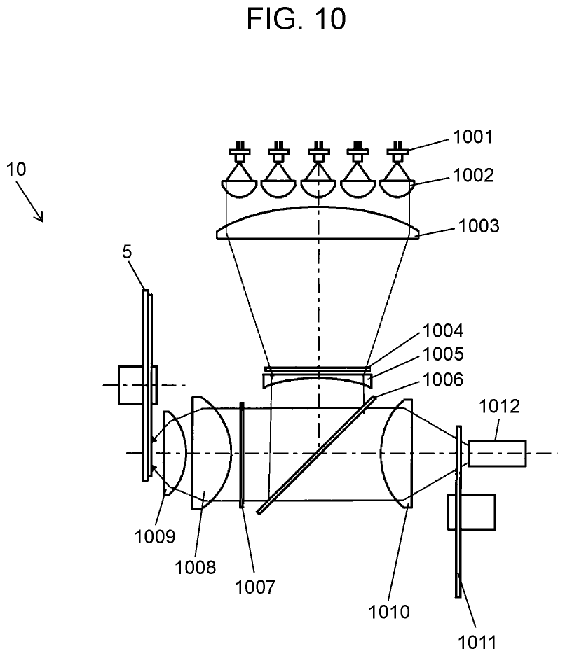

FIG. 10 shows the configuration of light source device 10 according to the first modified example of the fourth exemplary embodiment.

Light source device 10 includes phosphor wheel 5 of the third exemplary embodiment.

Light source device 10 further includes a plurality of semiconductor laser elements 1001, a plurality of collimator lenses 1002, convex lens 1003, diffusion plate 1004, concave lens 1005, polarization- and wavelength-selective mirror 1006, λ/4 retarder 1007, and convex lenses 1008 and 1009. These optical components are examples of the optical system for guiding lights from semiconductor laser elements 1001 to phosphor wheel 5. Light source device 10 further includes convex lens 1010, color wheel 1011, and rod integrator 1012.

Semiconductor laser elements 1001 are disposed so that lights from elements 1001 are s-polarized with respect to polarization- and wavelength-selective mirror 1006, which will be described later. The blue lights from elements 1001 are collimated by collimator lenses 1002 disposed on the emission side of elements 1001. The collimated lights are converged by convex lens 1003 disposed on the emission side of collimator lenses 1002. The converged lights enter diffusion plate 1004 disposed on the emission side of convex lens 1003. Diffusion plate 1004 reduces the ununiformity of the lights that remains unsolved by convex lens 1003.

The lights emitted through diffusion plate 1004 enter concave lens 1005 to be collimated.

The collimated lights emitted through concave lens 1005 enter polarization- and wavelength-selective mirror 1006 disposed on the emission side of concave lens 1005. Mirror 1006 is disposed at an angle of 45 degrees with respect to the optical axis of the lights coming from concave lens 1005. Mirror 1006 has the property of reflecting s-polarized blue lights and transmitting p-polarized blue lights and other lights (such as green and yellow). In other words, mirror 1006 reflects s-polarized blue lights emitted from elements 1001 and transmits p-polarized blue lights emitted from elements 1001. As will be described later, mirror 1006 transmits lights generated when the blue light excites light-incident layers 501 and 503 of phosphor wheel 5. Thus, the lights emitted through concave lens 1005 are reflected by mirror 1006. After being reflected by mirror 1006 and delayed by only λ/4 in a phase-delay axis direction by λ/4 retarder 1007, the blue lights enter convex lenses 1008 and 1009 in that order. As a result, the converged lights enter phosphor wheel 5.

Phosphor wheel 5 is disposed so that light-incident layers 501, 502a, 502b, and 503 face convex lens 1009. As mentioned above, when motor 508 rotates substrate 507 so that the spot of the incident light moves in the following order: layer 501, layer 502a, layer 503, layer 502b, layer 501, . . . , the lights are emitted in the following order of colors: green, blue, yellow, blue, green, . . . .

When the blue lights are converged by convex lenses 1008 and 1009, and enter layers 501 and 503, these layers 501 and 503 respectively emit green and yellow lights (fluorescent light). These green and yellow lights pass through convex lens 1009 and enter convex lens 1008 to be collimated. The collimated green and yellow lights enter λ/4 retarder 1007 and enter mirror 1006 in that order.

Polarization- and wavelength-selective mirror 1006 is disposed at an angle of 45 degrees with respect to the optical axis of the lights coming from λ/4 retarder 1007. Mirror 1006 has the property of transmitting green and yellow lights. Thus, the green and yellow lights coming from λ/4 retarder 1007 pass through mirror 1006 and enter convex lens 1010.

Meanwhile, when the blue lights are converged by convex lenses 1008 and 1009 and enter layers 502a and 502b, these blue lights are reflected by reflective layer 506 (and/or adhesive layer 505 and/or light-incident layer 504) without the conversion of their wavelength range. After being reflected, the blue lights pass through convex lens 1009 and enter convex lens 1008 to be collimated. The collimated blue lights enter λ/4 retarder 1007 and are delayed by only λ/4 in a phase-delay axis direction. The blue lights pass through λ/4 retarder 1007 twice in total, during which their phase changes by λ/2 and the polarization direction is rotated 90 degrees. As a result, the blue lights change from s-polarized lights to p-polarized lights. After passing through λ/4 retarder 1007, the blue lights enter mirror 1006.

As described above, mirror 1006 is disposed at an angle of 45 degrees with respect to the optical axis of the lights coming from λ/4 retarder 1007. Mirror 1006 has the property of reflecting s-polarized blue lights and transmitting p-polarized blue lights. Consequently, the p-polarized blue lights coming from layers 502a and 502b of phosphor wheel 5 pass through mirror 1006 and enter convex lens 1010.

After entering convex lens 1010, the green, yellow, and blue lights are converged by convex lens 1010, pass through color wheel 1011 and enter rod integrator 1012.

Color wheel 1011 is synchronized with phosphor wheel 5 by an unillustrated synchronous circuit. Color wheel 1011 includes a wavelength-selective coating laid in part of the angle range that enters the yellow lights from phosphor wheel 5. This coating has the property of transmitting only lights of yellow to red wavelength ranges. Thus, while color wheel 1011 makes one rotation, lights are emitted through rod integrator 1012 in the following order of colors: green, blue, yellow, red, and blue. These lights are combined in time so as to emit a white light.

The above-described light source device 9 includes phosphor wheel 5 of the third exemplary embodiment, but light source device may alternatively include phosphor wheel 6 of the first modified example of the third exemplary embodiment. As described above, phosphor wheel 6 includes two wavelength conversion composites that emit green and yellow lights, and adhesive layers 505a and 505b that emit blue lights. Thus, while phosphor wheel 6 makes one rotation, the lights are emitted in the following order of colors: green, yellow, blue, green, yellow, and blue. Color wheel 1011 is synchronized with phosphor wheel 6. Color wheel 1011 includes a wavelength-selective coating laid in part of the angle range that enters the yellow lights from phosphor wheel 6. This coating has the property of transmitting only lights of yellow to red wavelength ranges. Thus, while color wheel 1011 makes one rotation, lights are emitted through rod integrator 1012 in the following order of colors: green, yellow, red, blue, green, yellow, red, and blue. These lights are combined in time so as to emit a white light.

Polarization- and wavelength-selective mirror 1006 is disposed at an angle of 45 degrees with respect to the optical axis of the lights. Alternatively, however, mirror 1006 may be disposed at an angle other than 45 degrees in order to secure the property of reflecting s-polarized lights from elements 1001, and transmitting p-polarized lights from elements 1001 and the fluorescent light from phosphor wheels 5 and 6. Furthermore, color wheel 1011, which is disposed on the incidence side of rod integrator 1012, may alternatively be disposed on the emission side.

The configuration of a light source device according to the second modified example of the fourth exemplary embodiment will now be described in detail.

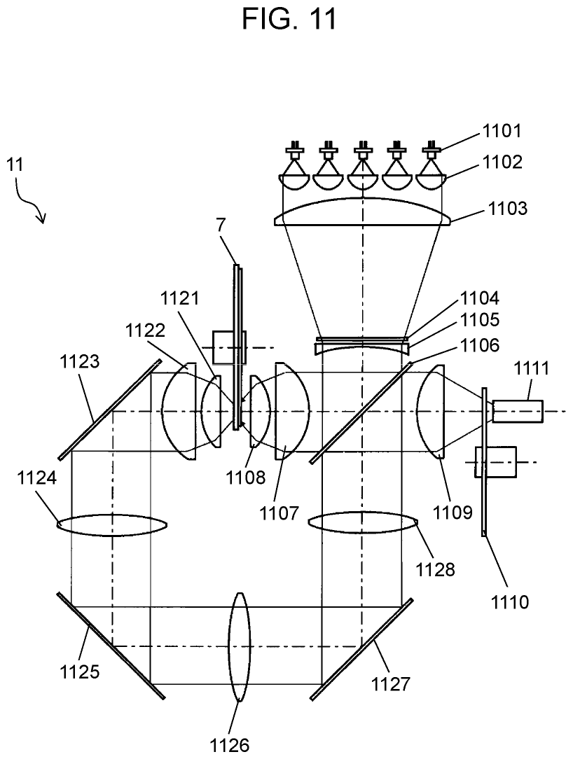

FIG. 11 is a configuration of light source device 11 according to the second modified example of the fourth exemplary embodiment.

Light source device 11 includes phosphor wheel 7 of the second modified example of the third exemplary embodiment.

Light source device 11 further includes a plurality of semiconductor laser elements 1101, a plurality of collimator lenses 1102, convex lens 1103, diffusion plate 1104, concave lens 1105, wavelength-selective mirror 1106, and convex lenses 1107 and 1108. These optical components are examples of the optical system for guiding lights from semiconductor laser elements 1101 to phosphor wheel 7. Light source device 11 further includes convex lenses 1121, 1122, 1124, 1126, and 1128, reflective mirrors 1123, 1125, and 1127, convex lens 1109, color wheel 1110, and rod integrator 1111.

In light source device 11, the lights from semiconductor laser elements 1101 do not need to have the same polarization direction. Light source device 11 includes wavelength-selective mirror 1106 instead of polarization- and wavelength-selective mirror 1006 shown in FIG. 10. Mirror 1106 is independent of the polarization direction similar to mirror 906 shown in FIG. 9. Mirror 1106 has the property of reflecting blue lights and transmitting lights of the other wavelength ranges (such as green and yellow). Light source device 11 does not have the counterpart of λ/4 retarder 1007 shown in FIG. 10. In the other aspects, the optical system of light source device 11 for guiding lights from semiconductor laser elements 1101 to phosphor wheel 7 has the same structure as the optical system shown in FIG. 10, so that its detailed description is omitted.

Phosphor wheel 7 is disposed so that light-incident layers 501, 502a, 502b, and 503 face convex lens 1108. As described above, when motor 508 rotates substrate 507A so that the spot of the incident light moves in the following order: layer 501, layer 502a, layer 503, layer 502b, layer 501, . . . , the lights are emitted in the following order of colors: green, blue, yellow, blue, green, . . . . In this case, the green and yellow lights are reflected by reflective layer 506 (and/or adhesive layer 505 and/or light-incident layer 504) and travel against the direction of the incident light. Meanwhile, the blue lights pass through openings 701a and 701b and are emitted in the same direction as the incident light travels.

When the blue lights are converged by convex lenses 1107 and 1108, and enter layers 501 and 503, these layers 501 and 503 respectively emit green and yellow lights (fluorescent light). These green and yellow lights pass through convex lens 1108 and enter convex lens 1107 to be collimated. The collimated green and yellow lights enter mirror 1106.

Mirror 1106 is disposed at an angle of 45 degrees with respect to the optical axis of the lights coming from convex lens 1107. Mirror 1106 has the property of transmitting green and yellow lights. Thus, the green and yellow lights coming from convex lens 1107 pass through mirror 1106 and enter convex lens 1109.

Meanwhile, when the blue lights are converged by convex lenses 1107 and 1108 and enter layers 502a and 502b (and layer 504), these blue lights pass through openings 701a and 701b without the conversion of their wavelength range.

After passing through openings 701a and 701b, the blue lights enter convex lenses 1121 and 1122 to be collimated. After that, the direction of the blue lights is changed by reflective mirrors 1123, 1125, and 1127 and convex lenses 1124, 1126, and 1128. Thus, the blue lights enter mirror 1106 at the surface opposite to the surface that enters the lights emitted from elements 1101.

Mirror 1106 is disposed at an angle of 45 degrees with respect to the optical axis of the lights coming from convex lens 1128. Mirror 1106 has the property of reflecting blue lights. Thus, the lights entering mirror 1106 from convex lens 1128 change direction by 90 degrees and enter convex lens 1109.

After entering convex lens 1109, the green, yellow, and blue lights are converged by convex lens 1109, pass through color wheel 1110, and enter rod integrator 1111.

Color wheel 1110 is synchronized with phosphor wheel 7 by an unillustrated synchronous circuit. Color wheel 1110 includes a wavelength-selective coating laid in part of the angle range that enters the yellow lights from phosphor wheel 7. This coating has the property of transmitting only lights of yellow to red wavelength ranges. Thus, while color wheel 1110 makes one rotation, lights are emitted through rod integrator 1111 in the following order of colors: green, blue, yellow, red, and blue. These lights are combined in time so as to emit a white light.

The above-described light source device 11 includes phosphor wheel 7 of the second modified example of the third exemplary embodiment, but light source device may alternatively include phosphor wheel 8 of the third modified example of the third exemplary embodiment. As described above, phosphor wheel 8 includes two wavelength conversion composites that emit green and yellow lights, and openings 801a and 801b that allow blue lights to pass through them. Thus, while phosphor wheel 8 makes one rotation, the lights are emitted in the following order of colors: green, yellow, blue, green, yellow, and blue. Color wheel 1110 is synchronized with phosphor wheel 8. Color wheel 1110 includes a wavelength-selective coating laid in part of the angle range that enters the yellow lights from phosphor wheel 8. This coating has the property of transmitting only lights of yellow to red wavelength ranges. Thus, while color wheel 1110 makes one rotation, lights are emitted through rod integrator 1111 in the following order of colors: green, yellow, red, blue, green, yellow, red, and blue. These lights are combined in time so as to emit a white light.

When a color wheel and a phosphor wheel are synchronized with each other, a yellow light may come both before and after a red light. This order of colors of lights is one example and can be changed depending on the configuration of the phosphor wheel and the color wheel.

### 4-2. Effects of the Light Source Devices

Light source light source devices 9, 10, and 11 according to the fourth exemplary embodiment have the following configuration.

Light source device 9 includes phosphor plate 4 and semiconductor laser elements 901. Light source device 10 includes phosphor wheel 5 or 6 and semiconductor laser elements 1001. Light source device 11 includes phosphor wheel 7 or 8 and semiconductor laser elements 1101. These semiconductor laser elements 901, 1001, and 1101 are examples of a light source element.

Thus, the configurations shown in FIGS. 9, 10, and 11 enable the manufacture of the light source devices easily, accurately and at low cost. The light source devices have the ability of emitting lights of different wavelength ranges in response to an incident light of a predetermined wavelength range by rotating the phosphor plate of the second exemplary embodiment or any of the phosphor wheels of the third exemplary embodiment without the need to align the light-incident layers having different optical characteristics. Such a light source device can be used in a projection display apparatus to improve the alignment accuracy during manufacture. This improves the yield and reduces the cost.

### Fifth Exemplary Embodiment

A projection display apparatus according to the fifth exemplary embodiment will now be described in detail.

### 5-1. The Configuration of the Projection Display Apparatus

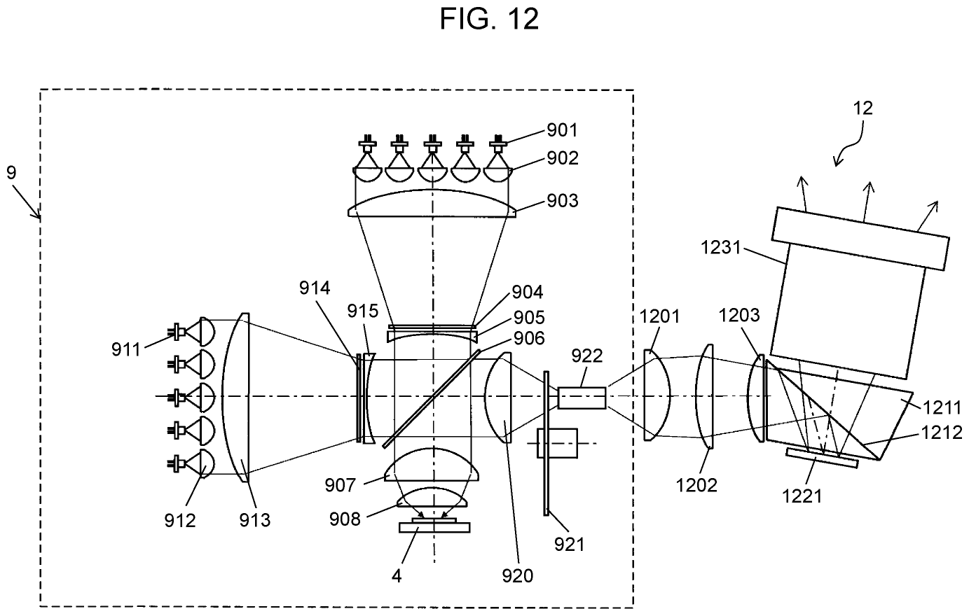

FIG. 12 shows the configuration of projection display apparatus 12 according to the fifth exemplary embodiment.

Projection display apparatus 12 includes light source device 9 of the fourth exemplary embodiment.

Light source device 9 of FIG. 12 has the same structure as light source device 9 of FIG. 9, so that its detailed description is omitted.

Apparatus 12 further includes relay lenses 1201, 1202, and 1203, total internal reflection prism 1211, minor gap 1212, digital micromirror device (DMD) 1221, and projection lens 1231.

The following description assumes that the lights are emitted through rod integrator 922 of light source device 9 in the following order of colors: green, yellow, blue, and red as described above.

Relay lenses 1201, 1202, and 1203 constitute a relay optical system for guiding lights from rod integrator 922 to total internal reflection prism 1211. Total internal reflection prism 1211 is composed of two prisms separated by minor gap 1212. The green, yellow, blue, and red lights emitted through rod integrator 922 pass through relay lenses 1201, 1202, and 1203, and enter prism 1211. In prism 1211, the lights are totally reflected by minor gap 1212 at an angle not less than the total reflection angle, thereby entering DMD 1221. Relay lenses 1201, 1202, and 1203 form an image at the end of rod integrator 922 onto DMD 1221.

DMD 1221 is a light modulation element that receives video signals according to the green, yellow, blue, and red lights from an unillustrated video circuit. DMD 1221 is synchronized with color wheel 921 and the video circuit by an unillustrated synchronous circuit. When receiving the green, yellow, blue, or red light from rod integrator 922, the pixels of DMD 1221 turn on and off according to the video signals, thereby changing the light direction.

The lights from the ON pixels of DMD 1221 enter total internal reflection prism 1211 again. In prism 1211, the lights pass through minor gap 1212 at an angle less than the total reflection angle and are emitted from prism 1211. After being emitted from prism 1211, the lights enter projection lens 1231 and are projected on an unillustrated screen in an enlarged scale.

A projection display apparatus according to the first modified example of the fifth exemplary embodiment will now be described in detail.

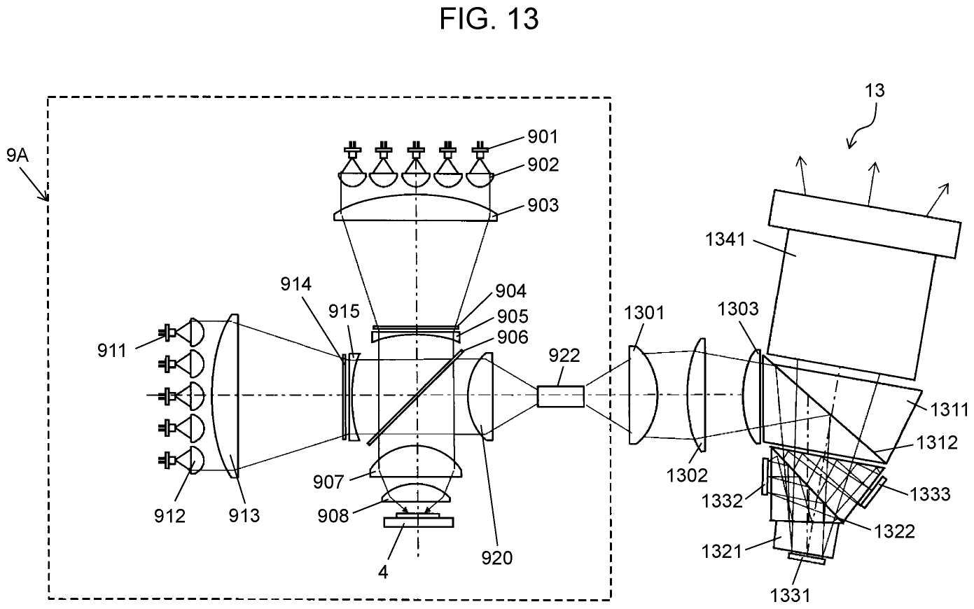

FIG. 13 shows the configuration of projection display apparatus 13 according to the first modified example of the fifth exemplary embodiment.

Projection display apparatus 13 includes light source device 9A as shown in FIG. 13.

Light source device 9A is similar in structure to light source device 9 shown in FIG. 9, except for non-use of color wheel 921. Rod integrator 922 of light source 9A emits green, yellow, and blue lights not sequentially but concurrently. They are identical in the other aspects, so that the detailed description is not repeated.

Apparatus 13 further includes relay lenses 1301, 1302, and 1303, which constitute a relay optical system for guiding lights from rod integrator 922 to total internal reflection prism 1311. Total internal reflection prism 1311 is composed of two prisms separated by minor gap 1312. The green, yellow, and blue lights emitted through rod integrator 922 pass through relay lenses 1301, 1302, and 1303, and enter prism 1311. In prism 1311, the lights are totally reflected by minor gap 1312 at an angle not less than the total reflection angle, thereby entering color separation and combination prism 1321.

Color separation and combination prism 1321 is separated from total internal reflection prism 1311 by a minor gap. Prism 1321 is composed of three glass blocks (first, second, and third blocks in the order of being closer to total internal reflection prism 1311). Between the first and second glass blocks, a wavelength-selective coating is laid that reflects blue lights onto the first glass block and transit lights of the other wavelength ranges. The second glass block contains minor gap 1322. Between the second and third glass blocks, a wavelength-selective coating is laid that reflects red lights and transmits green lights.

Of the lights that have traveled through rod integrator 922, prism 1311, and prism 1321 in that order, only the blue lights are reflected by the wavelength-selective coating laid between the first and second glass blocks of prism 1321. The other lights pass through the coating. The blue lights reflected by this coating change direction to the incidence side of prism 1321. The blue lights are reflected by the incidence side of prism 1321 at an angle not less than the total reflection angle and enter DMD 1333.

The lights other than the blue lights that have passed through the wavelength-selective coating laid between the first and second glass blocks of prism 1321 travel straight. Of these lights, the green lights pass through the coating laid between the second and third glass blocks of prism 1321, whereas the red lights are reflected by the same coating to change direction back to the first glass block.

The red lights that have been reflected by the wavelength-selective coating laid between the second and third glass blocks of prism 1321 change direction to the first glass block. The red lights are then reflected by minor gap 1322 existing between the first and second glass blocks at an angle less than the total reflection angle to enter DMD 1332.

Meanwhile, the green lights that have passed through the wavelength-selective coating laid between the second and third glass blocks of prism 1321 pass through the third glass block and enter DMD 1331.

DMDs 1331, 1332, and 1333 are light modulation elements that receive video signals according to the green, red, and blue lights from the unillustrated video circuit. The pixels of DMDs 1331, 1332, and 1333 turn on and off according to the video signals, thereby changing the light direction.

The green lights from the ON pixels of DMD 1331 enter the third glass block of prism 1321 again, pass through the wavelength-selective coating laid between the third and second glass blocks and then the wavelength-selective coating laid between the second and first glass blocks, and are emitted toward total internal reflection prism 1311.

Meanwhile, the red lights from the ON pixels of DMD 1332 enter the second glass block of prism 1321 again and are reflected by minor gap 1322 existing between the first and second glass blocks at an angle not less than the total reflection angle. The red lights are then reflected by the wavelength-selective coating laid between the second and third glass blocks so as to be combined with the above-mentioned green lights, and pass through the wavelength-selective coating laid between the first and second glass blocks, thereby being emitted toward total internal reflection prism 1311.

Finally, the blue lights from the ON pixels of DMD 1333 enter the first glass block of prism 1321 again and are reflected by the gap existing between prisms 1311 and 1321 at an angle not less than the total reflection angle. The blue lights are then reflected by the wavelength-selective coating laid between the first and second glass blocks of prism 1321 so as to be combined with the above-mentioned green and red lights, thereby being emitted toward total internal reflection prism 1311.

Thus, the green, red, and blue lights from the ON pixels of DMDs 1331, 1332, and 1333 are combined by prism 1321 and enter prism 1311. In prism 1311, the lights pass through minor gap 1312 at an angle less than the total reflection angle and emitted from prism 1311. After being emitted from prism 1311, the lights enter projection lens 1341 and are projected on an unillustrated screen in an enlarged scale.

A projection display apparatus according to the second modified example of the fifth exemplary embodiment will now be described in detail.

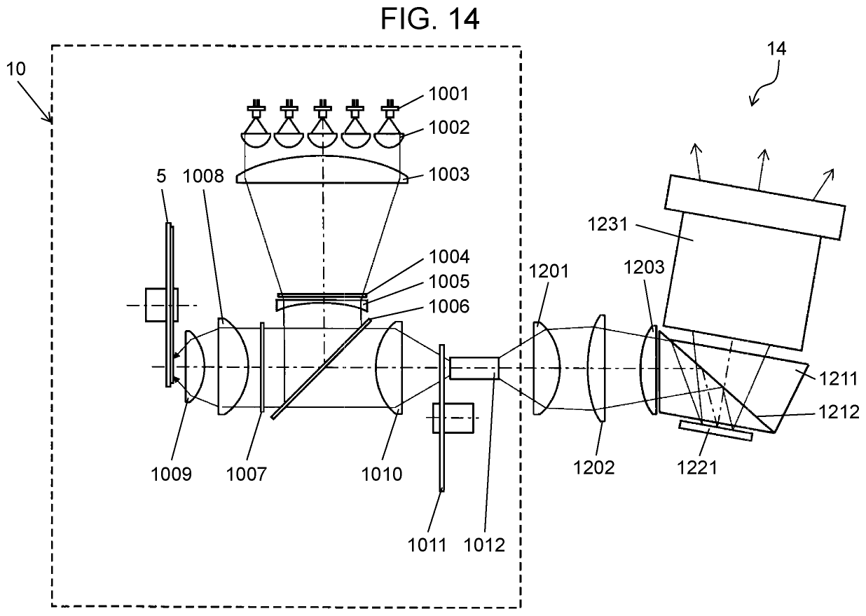

FIG. 14 shows the configuration of projection display apparatus 14 according to the second modified example of the fifth exemplary embodiment.

Apparatus 14 includes, instead of light source device 9 shown in FIG. 12, light source device 10 of the first modified example of the fourth exemplary embodiment. Light source device 10 shown in FIG. 14 has the same structure as light source device 10 shown in FIG. 10, so that it will not be described again. The components located after relay lens 1201 have the same structures and operations as their counterparts shown in FIG. 12, so that they will not be describe again.

A projection display apparatus according to the third modified example of the fifth exemplary embodiment will now be described in detail.

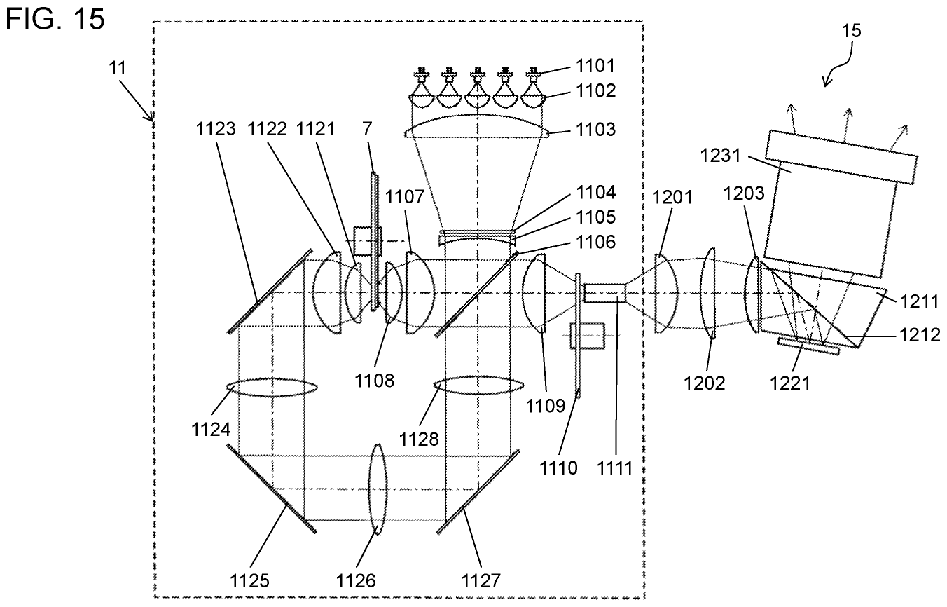

FIG. 15 shows the configuration of projection display apparatus 15 according to the third modified example of the fifth exemplary embodiment.

Apparatus 15 includes, instead of light source device 10 shown in FIG. 14, light source device 11 of the second modified example of the fourth exemplary embodiment. Light source device 11 shown in FIG. 15 has the same structure as light source device 11 shown in FIG. 11, so that it will not be described again. The components located after relay lens 1201 have the same structures and operations as their counterparts shown in FIG. 14, so that they will not be describe again.

### 5-1. Effects of the Projection Display Apparatuses

Projection display apparatuses 12, 13, 14, and 15 according to the fifth exemplary embodiment have the following configuration.

Projection display apparatuses 12, 13, 14, and 15 include light source devices 9, 9A, 10, and 11, respectively, and DMDs 1221, 1331, 1332, and 1333, respectively, which are examples of the light modulation element. Apparatuses 12, 13, 14, and 15 further include first and second optical systems. The first optical system allows the lights generated by light source devices 9, 9A, 10, and 11 to enter DMDs 1221, 1331, 1332, and 1333, respectively. The second optical system projects the lights spatially modulated by DMDs 1221, 1331, 1332, and 1333.

Thus, the configurations shown in FIGS. 12, 13, 14, and 15 enable the manufacture of the projection display apparatuses including the light source device of the fourth exemplary embodiment easily, accurately and at low cost. The light source device has the ability of emitting lights of different wavelength ranges in response to an incident light of a predetermined wavelength range without the need to align the light-incident layers having different optical characteristics. Such a light source device can be used in a projection display apparatus to improve the alignment accuracy during manufacture. This improves the yield and reduces the cost.

### INDUSTRIAL APPLICABILITY

The wavelength conversion composite according to the aspect of the present disclosure is applicable to a phosphor plate, a phosphor wheel, a light source device, and a projection display apparatus.

What is claimed is:

1. A wavelength conversion composite comprising:
a plurality of light-incident layers configured to emit lights of different wavelength ranges in response to an incident light,
wherein the plurality of light-incident layers are disposed in layers on a same plane, adjacent edges of two adjacent light-incident layers among the plurality of light-incident layers being in contact with each other so that the plurality of light-incident layers form an integral whole.

2. The wavelength conversion composite according to claim 1, wherein at least one of the plurality of light-incident layers comprises a wavelength conversion material configured to emit a light of a wavelength range different from a wavelength range of the incident light.

3. The wavelength conversion composite according to claim 1, further comprising:
a support layer, disposed on a surface of the plurality of light-incident layers, for supporting the plurality of light-incident layers.

4. The wavelength conversion composite according to claim 3, wherein the support layer comprises a transparent material.

5. The wavelength conversion composite according to claim 3, wherein the support layer comprises a reflective material.

6. The wavelength conversion composite according to claim 5, wherein the reflective material comprises sintered titanium oxide.

7. The wavelength conversion composite according to claim 3, wherein the support layer comprises a wavelength conversion material configured to emit a light of a wavelength range different from a wavelength range of the incident light.

8. A phosphor plate comprising:
the wavelength conversion composite according to claim 1; and
a substrate fixedly bonded to the wavelength conversion composite.

9. The phosphor plate according to claim 8, further comprising:
a reflective layer disposed between the wavelength conversion composite and the substrate.

10. A phosphor wheel comprising:
the phosphor plate according to claim 8; and
a motor configured to rotate the phosphor plate,
wherein
the substrate of the phosphor plate is disc-shaped, and
the wavelength conversion composite of the phosphor plate is either ring-shaped or ring segment-shaped.

11. The phosphor wheel according to claim 10, wherein
the substrate has an opening or a cutout portion, and
at least one of the plurality of light-incident layers of the wavelength conversion composite is a transmissive element comprising a transparent material, the transmissive element being vertically aligned with the opening or the cutout portion.

12. A light source device comprising:
the phosphor plate according to claim 8; and
a light source element configured to emit a light to the phosphor plate.

13. A light source device comprising:
the phosphor wheel according to claim 10; and
a light source element configured to emit a light to the phosphor wheel.

14. A projection display apparatus comprising:
the light source device according to claim 12;
a light modulation element;
a first optical system configured to allow a light emitted by the light source device to enter the light modulation element; and
a second optical system configured to project a light spatially modulated by the light modulation element.

15. A method of manufacturing the wavelength conversion composite according to claim 1, the method comprising:
molding a yet-to-be-sintered material of the plurality of light-incident layers; and
integrally sintering the molded yet-to-be-sintered material of the plurality of light-incident layers.
